(19) United States
(12) Patent Application Publication
(10) Pub. No.: US 2006/0280077 A1
(43) Pub. Date: Dec. 14, 2006

(54) Disk recorder

(75) Inventor: Koji Suwa, Kato-gun Hyogo (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/446,197

(22) Filed: Jun. 5, 2006

(30) Foreign Application Priority Data
Jun. 8, 2005 (JP) 2005-167857

(51) Int. Cl. G11B 7/00; G11B 20/10

(52) U.S. Cl. 369/47.24; 369/44.31

(57) ABSTRACT

A disk recorder for data reading and writing operations to a disk includes an access-mode switcher and an accessor. The access-mode switcher selects between a random access mode and a sequential access mode in respect to a mode for data writing and reading to and from the disk. The accessor accepts a random access command from a host and performing a random access operation accordingly in the random access mode while accepting a sequential access command from the host and performing a sequential access operation accordingly in the sequential access mode.

### BACKGROUND OF THE INVENTION

1. Field of the Invention

The present invention relates to disk recorders which perform data reading and writing operations to disk-shaped recording media such as DVD disks and MO disks.

2. Description of the Related Art

There are two major purposes in data processing by a computer system. The first purpose is to process or generate some specific data which are to be used for a specific application task. The second purpose is to prepare backup of those data for emergencies such as unforeseen system down.

In order to achieve the first purpose, the computer system is required to perform fast access to specific data to be processed. To realize that, a fast accessible storage, such as a magnetic disk storage (otherwise known as a hard disk drive) is employed. By ordinary, a magnetic disk storage is incorporated in the computer system as an auxiliary storage. Further, a magnetic disk storage employs a file system, such as an OS, which allows management of data to be processed in the form of files. In conformity with the file system, the computer system performs random access to the magnetic disk storage.

In order to achieve the second purpose, the computer system requires a storage medium which stores a large amount of data certainly without any partial loss of data. For this purpose, magnetic tapes are used. A magnetic tape storage performs data-reading from or data-writing to magnetic tapes. By ordinary, a magnetic tape storage does not employ a file system, but stores data based on a basic recording format. The computer system performs sequential access to the magnetic tape storage so that the computer system can handle data even if the file system does not function due to an unforeseen system down.

Nowadays, disk storage media, such as DVDs or MO disks, have been used widely as storage media with large memory capacity and high reliability. For this reason, magnetic tapes, which have demerits such as tendency for deterioration of stored data or relatively poor usability, have been replaced by disk storage media. Therefore, disk storage media which can be utilized for both of the first and second purpose are desired.

A disk storage, however, is basically forced to employ a file system in conformity with the computer system, and thereby to perform random access to disk storage media. On the contrary, as described above, a storage medium is needed to be accessed through sequential access when the storage medium is used for backup. Therefore, a disk storage medium cannot be utilized for backup essentially.

Therefore, some disk storages, which perform data-reading from or data-writing to such kind of disk storage media, have emulating function which enables disk storage media to be utilized for backup. JP-A-2000-311066 Gazette discloses an example of such a type of conventional disk storages.

As described above, a conventional disk storage is required to include an I/O emulator to accept sequential access from the host of the computer system. In addition, the I/O emulator must be removed when the disk storage accepts sequential access, while the I/O emulator must be put when the disk storage accepts random access. In this way, a conventional disk storage has a drawback that it cannot always accept in real time the access method which the host desire.

### SUMMARY OF THE INVENTION

The present invention has been proposed under the above-described circumstances. It is therefore an object of the present invention to provide a disk recorder which has random access and sequential access capabilities readily available upon selection thereby offering improved usability in switching between these capabilities.

According to a first aspect of the present invention, there is provided a disk recorder for data-reading from or data-writing to a disk which serves as a recording medium based on a command from a host. The disk recorder comprising: an access-mode switcher for selecting a mode from a random access mode and a sequential access mode, the mode being employed in data-reading from or data-writing to the disk; and an accessor for, in case of the random access mode, receiving a random access command from the host and performing a random access operation based on the random access command, and for, in case of the sequential access mode, receiving a sequential access command from the host and performing a sequential access operation based on the sequential access command.

Preferably, the disk recorder may further comprise an emulator for conversion of the sequential access command into a command compliant with the accessor so as to enable the accessor to perform a sequential access operation based on the converted command.

Preferably, the access-mode switcher may select either the random access mode or the sequential access mode depending on a request from the host. Preferably, the disk recorder may further comprise a message notifier for notification to the host, under the random access mode, in response to setting of a disk which contains data already recorded by sequential accessing, of a warning message not to delete data on the disk.

Preferably, the disk recorder may further comprise a message notifier for notification to the host, under the sequential access mode, in response to setting of a disk which contains data already recorded by random accessing, of a warning message not to delete data on the disk.

According to a second aspect of the present invention, there is provided a computer program for a disk recorder for data-reading from or data-writing to a disk which serves as a recording medium based on a command from a host. The program causes a computer to execute: an access-mode switching procedure of selecting a mode from a random access mode and a sequential access mode, the mode being employed in data-reading from or data-writing to the disk; and an accessing procedure of, in case of the random access mode, receiving a random access command from the host and performing a random access operation based on the random access command, and of, in case of the sequential access mode, receiving a sequential access command from the host and performing a sequential access operation based on the sequential access command.

According to the arrangements disclosed above, a simple switching operation to the random access mode or to the sequential access mode automatically completes necessary changes to use the selected mode. Whichever of the random access capability and the sequential access capability becomes readily available upon selection, so it becomes possible to offer improved usability in switching between the two capabilities.

Other characteristics and advantages of the present invention will become clearer from the following detailed description to be made with reference to the attached drawings.

### BRIEF DESCRIPTION OF THE DRAWINGS

FIG. 1 is a block diagram of a disk recorder according to the present invention;

FIG. 2 is a chart for describing a command used in the disk recorder in FIG. 1;

FIG. 3 is a chart for describing a command conversion table used in the disk recorder in FIG. 1;

FIG. 4 is a chart for describing a disk format structure used in the disk recorder in FIG. 1;

FIG. 5 is a flowchart for describing an access procedure in the disk recorder in FIG. 1; and

FIG. 6 is a flowchart showing steps following A and B in FIG. 5.

### DETAILED DESCRIPTION OF THE PREFERRED EMBODIMENT

Hereinafter, a preferred embodiment of the present invention will be described with reference to the accompanying drawings.

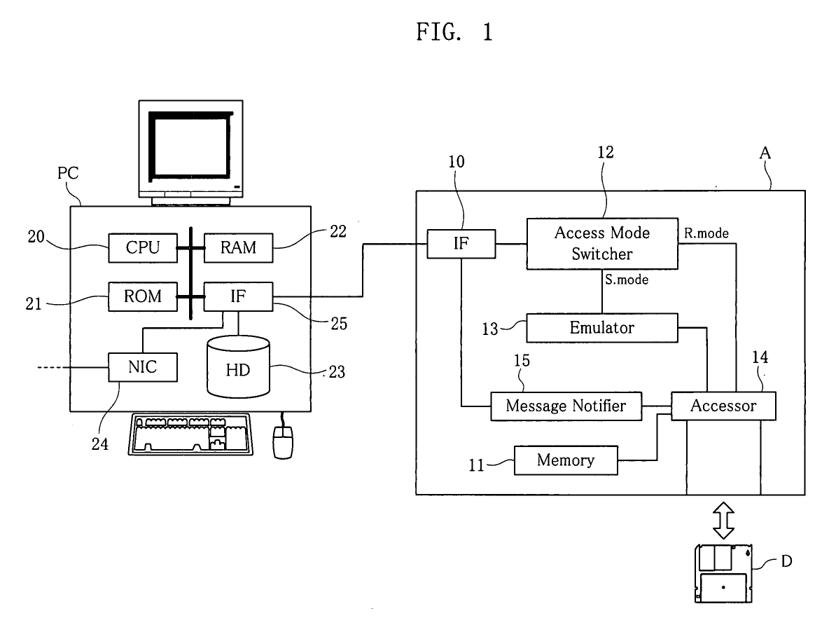

As shown in FIG. 1, a disk recorder A according to an embodiment performs data reading and data writing operations to an MO disk D as a medium, and is connected with a host computer PC. The disk recorder A incorporates a micro computer as well as an interface 10 for connection with a host computer PC and a memory 11. The disk recorder A includes an access mode switcher 12, an emulator 13, an accessor 14 and a message notifier 15, each as a function provided by the micro computer based upon firmware (a program for fundamental control). The disk recorder A has random access capability for data reading and writing operations to an MO disk D quickly through random access, and sequential access capability for data reading and writing operations through sequential access like a tape recording device. Generally, sequential access is used to read and write backup data including system files of an OS whereas random access is used to read and write files made by application software, etc.

The host computer PC is provided by e.g. a personal computer, and includes a CPU 20, a ROM 21, a RAM 22, a hard disk drive 23, a network interface card 24, an interface 25, etc. The hard disk drive 23 stores different kinds of data and programs, and data transfer is made between the hard disk drive 23 and the disk recorder A. The host computer PC is connected with Internet via the network interface card 24, and is capable of downloading and updating the firmware for the disk recorder A through Internet. The disk recorder A is connected with the host computer PC via the interfaces 10, 25 in conformity with e.g. ATAPI (AT Attachment Packet Interface) standards. The host computer PC exchanges a variety of commands with the disk recorder A in order to make directions of reading data from or writing data to the MO disk D.

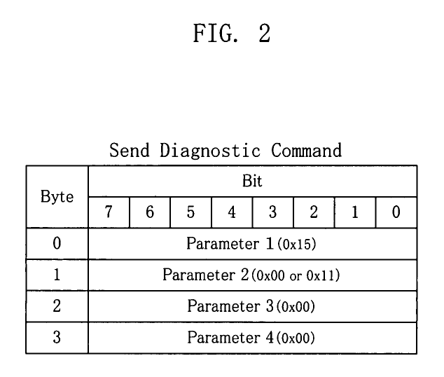

As shown e.g. in FIG. 2, the access mode switcher 12 of the disk recorder A makes a switching operation between a random access mode (hereinafter abbreviated as “R-mode”) and a sequential access mode (hereinafter abbreviated as “S-mode”), responding to a “Send Diagnostic” command which is sent from the host computer PC as a request for diagnosis. The “Send Diagnostic” command is made of e.g. four parameters 1 through 4. If a reserve parameter 2 is “0x00”, the command is a direction to switch to the R-mode whereas it is a direction to switch to the S-mode if the parameter is “0x11”.

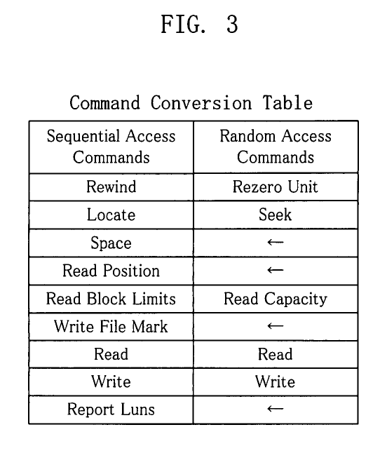

In the S-mode, the emulator 13 converts sequential access commands which are used in communications with the host computer PC into random access commands using a command conversion table as shown in FIG. 3. After the command conversion, the emulator 13 provides control for the accessor 14 to perform a sequential access. For example, as shown in the figure, if the host computer PC sends a “Rewind” command which is a request for a tape recording device to do rewinding operation, the emulator 13 converts the “Rewind” command into a “Rezero Unit” command. This command brings a pointer which specifies the starting point for reading or writing back to the beginning of the current partition. Some of the sequential access commands, such as “Space” command, which moves the pointer from the current point to a specified point, do not have a corresponding random access counterpart. For these commands, the table gives the same command as a conversion since the accessor 14 can handle these commands.

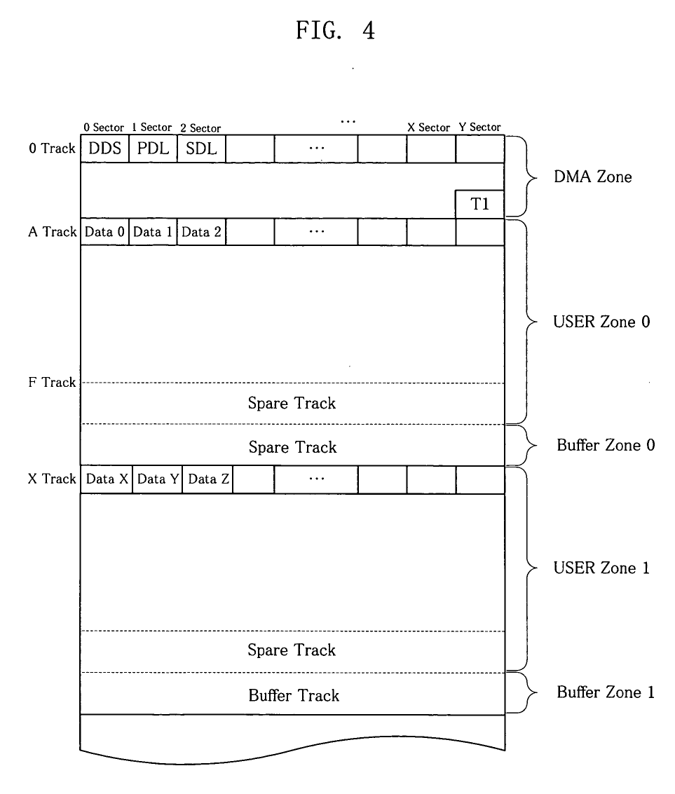

The accessor 14 performs random access in its reading/writing operations to the MO disk D in the R-mode while it performs sequential access in its reading/writing operations in the S-mode. As for formatting of the MO disk D which serves as a target of reading/writing, logical format structures for the R-mode are already public, so no pictorial description is given here to illustrate the format structures. For the S-mode, a logical format structure is shown in FIG. 4, which includes a DMA (Defect Management Area) zone, a USER zone, and a buffer zone between the USER zones. The DMA zone includes: DDS as an indication of digital data storage; PDL (Primary Defect List) which indicates defective sectors detected at the time of certifying operation; and an SDL (Secondary Defect List) which indicates secondary defective sectors detected at the time of verifying operation. The DMA zone also includes device type information, whose value is e.g. “T1” meaning a sequential access device, stored in formatting. When formatting as a random access device, device type information “T0” is stored in the DMA zone. The device type cannot be changed as a rule, unless the medium is re-formatted. In the sequential access method, the USER zone sequentially stores packets of data. The buffer zone divides the USER zone for each file. Though not illustrated in particular, directory and other information is written to the USER zone after the sequential access data writing has been completed, e.g. right before the MO disk D is unloaded from the disk recorder A.

When an MO disk D is set to the disk recorder A, the message notifier 15 sends a notification to the host computer PC that data-writing is prohibited, depending on the type of the MO disk D. Specifically, in S-mode, if the device type of the MO disk D is “T0” which means random access type, the message notifier sends the host computer PC a message telling e.g. “Data cannot be deleted from the disk. Use a disk of sequential access type.” On the other hand, in R-mode, if the device type of the MO disk D is “T1” which means sequential access type, the message notifier sends the host computer PC a message telling e.g. “Data cannot be deleted from the disk. Use a disk of random access type.” The host computer PC displays the received message, so it is possible to prevent the data from being deleted by e.g. an inadvertent execution of a formatting operation of the MO disk D which already contains recorded data.

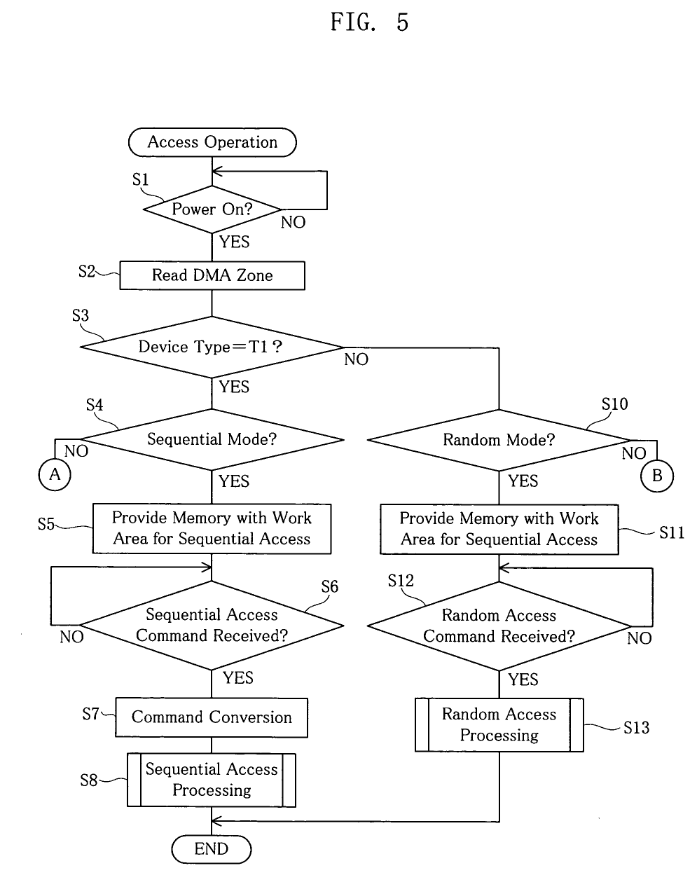

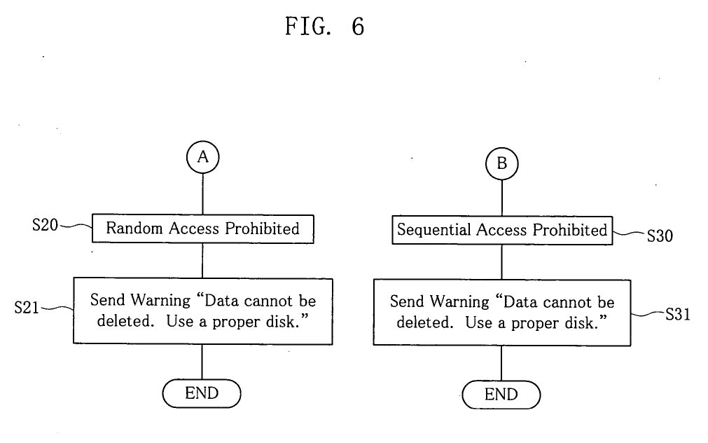

Next, description will be made for an access operation of the disk recorder A, with reference to FIG. 5 and FIG. 6.

As shown in FIG. 5, when the power to the disk recorder A is turned ON (S1: YES), the accessor 14 reads the DMA zone of the MO disk D (S2) to get the device type (S3).

Assume that the device type is “T1” which indicates the sequential access type (S3: YES). The host computer PC then sends a “Send Diagnostic” command, and if the parameter 2 contained in this “Send Diagnostic” command is “Oxll”, the access mode switcher 12 determines that the current mode is the S-mode (S4: YES).

Under the S-mode, the accessor 14 sets a work area in the memory 11 for sequential access operations (S5). The above-described command conversion table is loaded into the sequential access work area, for example.

Thereafter, upon reception of a sequential access command from the host computer PC (S6: YES), the emulator 13 converts the received sequential access command into a random access command using the command conversion table (S7). If the sequential access command does not have a corresponding random access command, the sequential access command is used as it is.

Thereafter, the accessor 14 performs a sequential access operation in accordance with the converted command (S8), and completes the current cycle of access operation. For example, if the host computer PC sends a sequential access command requesting to store backup data, the accessor 14 performs a sequential access operation of writing the backup data to the MO disk D.

If Step S6 does not find a sequential access command sent from the host computer PC (S6: NO), the access mode switcher 12 and the accessor 14 wait until a command is received.

If Step S4 finds that the parameter 2 contained in the “Send Diagnostic” command from the host computer PC has a value “0x00” which means the R-mode, contrary to the device type which is the sequential type, the accessor 14 prohibits the reading/writing operation as shown in FIG. 6, to the MO disk D through random access (S20).

Further, the message notifier 15 sends the host computer PC a message such as “Data cannot be deleted. Use a proper disk” (S21). Thus, the MO disk D which is formatted for sequential access operations is not accessed under the random access mode.

If Step S3 finds that the device type is “T0” which means the device is a random access device (S3: NO), the access mode switcher 12 checks a “Send Diagnostic” command which comes thereafter from the host computer PC, to see if the parameter 2 contained in this “Send Diagnostic” command has a value “0x00” which is a command to set to the R-mode (S10).

If the mode specified in command is the R-mode (S10: YES), the accessor 14 sets a random access work area in the memory 11 (S11). The random access work area is used as a transfer buffer, for example, in data exchange operations with the host computer PC.

Thereafter, upon receiving a random access command from the host computer PC (S12: YES), the access mode switcher 12 performs a random access operation in accordance with the received random access command (S13), and then finishes this cycle of access operation. For example, if the host computer PC sends a random access command requesting to store a file which was created by application software, the accessor 14 performs a random access operation of writing the file to the MO disk D.

If Step S12 finds no random access command from the host computer PC (S12: NO), the access mode switcher 12 and the accessor 14 waits until a command is received.

If Step S10 finds that the parameter 2 contained in the “Send Diagnostic” command has a value “Oxll” which means the S-mode, contrary to the device type which is the random access type, the accessor 14 prohibits the reading/writing operation as shown in FIG. 6, to the MO disk D through sequential access (S30).

Further, the message notifier 15 sends the host computer PC a message such as “Data cannot be deleted. Use a proper disk.” Thus, the MO disk D which is formatted for random access operations is not accessed under the sequential access mode.

Therefore, according to the disk recorder A offered by the present embodiment, even if the host computer PC issues a sequential access command targeted to a tape recording device, it is possible to read/write data in response to the given sequential access command as long as the MO disk D is formatted for the sequential access operations. It is therefore possible to make whichever of the random access capability and the sequential access capability readily available upon selection, and to offer improved usability in switching between the two capabilities.

The present invention is not limited to the embodiment described hereinabove.

For example, according to the embodiment described above, there is a specific command from the host computer which includes a parameter for switching the access mode, and the access mode is switched based on the parameter. Alternatively however, the access mode switcher may be provided by a dip switch, and the access mode may be switched by setting a jumper pin on the dip switch.

Further, the disk which serves as the recording medium is not limited to MO disks either. For example, the disk may be provided by CD-R, CD-RW, DVD+RW or whatsoever as long as the media is readable and writable.

1. A disk recorder for data-reading from or data-writing to a disk which serves as a recording medium based on a command from a host, the disk recorder comprising:
an access-mode switcher for selecting a mode from a random access mode and a sequential access mode, the mode being employed in data-reading from or data-writing to the disk; and
an accessor for, in case of the random access mode, receiving a random access command from the host and performing a random access operation based on the random access command, and for, in case of the sequential access mode, receiving a sequential access command from the host and performing a sequential access operation based on the sequential access command.

2. The disk recorder according to claim 1, further comprising an emulator for conversion of the sequential access command into a command compliant with the accessor so as to enable the accessor to perform a sequential access operation based on the converted command.

3. The disk recorder according to claim 1, wherein the access-mode switcher selects either the random access mode or the sequential access mode depending on a request from the host.

4. The disk recorder according to one of claim 1, further comprising a message notifier for notification to the host, under the random access mode, in response to setting of a disk which contains data already recorded by sequential accessing, of a warning message not to delete data on the disk.

5. The disk recorder according to one of claim 1, further comprising a message notifier for notification to the host, under the sequential access mode, in response to setting of a disk which contains data already recorded by random accessing, of a warning message not to delete data on the disk.

6. A computer program for a disk recorder for data-reading from or data-writing to a disk which serves as a recording medium based on a command from a host, the program causes a computer to execute:
an access-mode switching procedure of selecting a mode from a random access mode and a sequential access mode, the mode being employed in data-reading from or data-writing to the disk; and
an accessing procedure of, in case of the random access mode, receiving a random access command from the host and performing a random access operation based on the random access command, and of, in case of the sequential access mode, receiving a sequential access command from the host and performing a sequential access operation based on the sequential access command.
